(19) United States
(12) Patent Application Publication
(10) Pub. No.: US 2017/0245510 A1
(43) Pub. Date: Aug. 31, 2017

(54) Chicken wing cutter

(71) Applicant: Mamie Powell Robinson, Chicago, IL (US)

(72) Inventor: Mamie Powell Robinson, Chicago, IL (US)

(73) Assignee: Mamie Robinson, Chicago, IL (US)

(21) Appl. No.: 14/998,885

(22) Filed: Feb. 29, 2016

(51) Int. Cl. A22C 21/00

(52) U.S. Cl. CPC A22C 21/0023

(57) ABSTRACT

A chicken wing cutter is provided having a safe and sanitary way to cut chicken wings. The chicken wings cutter is a device that holds chicken wings in place and cut them without having and safely and cut the chicken wing without the use of knives or machinery. to hold and touch the chicken to contamination or carrying of such bacteria caused while handling poultry. The device allows you the place the chicken in the mode The chicken cutter cut the chicken in three precise pieces in predation for cooking chicken wings. The device has blades within the lid that retract once the lid is closed and cut the chicken is released the chicken into a tray that is beneath the device once the lid is reopened.

### DESCRIPTION OF INVENTION

My invention is called the Chicken Wing Cutter. It was created by me to assist in preparing chicken wings for my family. It was designed to help me when cutting chicken wings to avoid and accidents in the kitchen while preparing hot wings for my family. The chicken wing cutter is a device that cuts the wings in to three pieces by placing the wings in the device that cuts them precisely in the middle of the chicken. This allows you to have a perfectly cut chicken wings chicken to prepare for your meals. Many restaurants use large machinery to cuts wings or whole chickens and many family use sharp knives. This device will eliminate any danger to one self while cutting chicken wings and will avoid purchasing expensive machinery to cut chicken wings. This also free one from touching the chicken to avoid contamination and bacteria from the handling poultry.

### DESCRIPTION OF ITEM

It will be in many in colors, oval in shape device that cut ten chicken wings at a time and separate section for whole chicken. The chicken is place in the device in individual mode that are shapes of chicken wings, five at one level and five at second level. The device has a lid that close and once it's closed, the chicken is cut into pieces.

### HOW TO USE ITEM

Place the chicken wings and whole chicken in the individual sections of the device. Close the lid once close the blades are released and the device will cut wings into three pieces depositing at the bottom in a tray of the device, therefore 10 pieces of chicken wings will be 20 pieces of chicken once cutting is complete.

### BRIEF DESCRIPTION OF THE CHICKEN CUTTER DRAWINGS

FIG. 1

The picture of how the Chicken cutter and show how many pieces of chicken it can hold and how it is designed to look.

FIG. 2

Is the right side version of the chicken cutter when it is closed.

FIG. 3

A picture of the front of the chicken cutter when closed.

FIG. 4

Is a drawing of the left side of the chicken cutter when closed

FIG. 5

Is a drawing of the right side of chicken cutter when opened.

FIG. 6

Is a drawing of the blades inside the Chicken Cutter that are used to cut the chicken into pieces when lid is closed.

FIG. 7

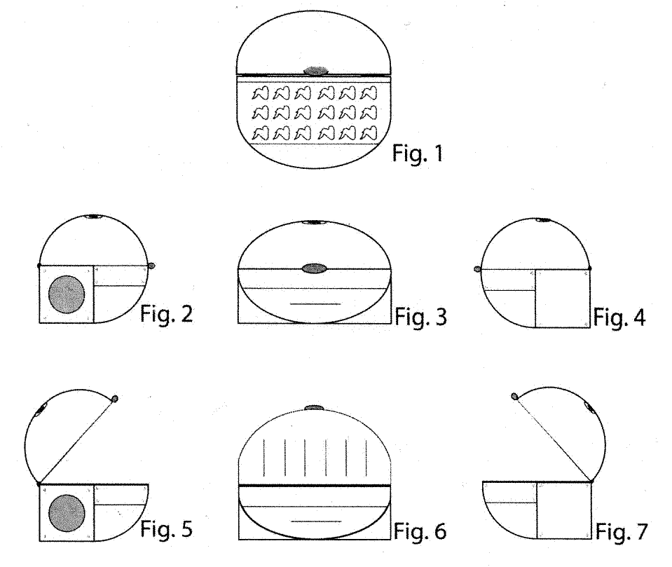

Is a drawing of the left side of Chicken Cutter when opened.

1. A device that is used for cutting chicken wings into three separate pieces, without the use of a hand knife or large machinery comprising of the steps:
(a) Placing the said pieces of chicken in the device so at the chicken is place directly into the mode and shape of the chicken wing.
(b) Closing the upper lid of the device so that the blades project from underneath the device cutting the chicken wing into three pieces once it is closed.
(c) once the lid is open the blade retract which releases the chicken to fall into the tray beneath to catch the cut pieces of chicken freeing ones hands from touch the chicken, reducing contamination and obtaining a precise cut.
